(19) United States
(12) Patent Application Publication
(10) Pub. No.: US 2004/0242207 A1
(43) Pub. Date: Dec. 2, 2004

(54) [APPARATUS FOR DETECTING AND DECODING MUSIC FORMAT AND DIGITAL MUSIC SHARING METHOD FOR MOBILE PHONES]

(76) Inventor: Chao-Wen Chi, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,820

(22) Filed: Aug. 19, 2003

(30) Foreign Application Priority Data
May 28, 2003 (TW) 92114348

(51) Int. Cl. H04M 3/16

(52) U.S. Cl. 455/412.2

(57) ABSTRACT

An apparatus for detecting and decoding music format for mobile phones and a digital music sharing method are disclosed. The apparatus for detecting and decoding music format for mobile phones comprises a receiver, for receiving a digital music file and a data processing unit, for detecting the format of the digital music file and decoding the digital music file responsive to the detected format of the digital music file. The method of sharing digital music for mobile phones comprises providing a digital music file, transmitting the digital music file to a mobile phone, wherein the mobile phone detects the format of the digital music file and decodes the digital music file.

### CROSS REFERENCE TO RELATED APPLICATIONS

This application claims the priority benefit of Taiwan application serial no. 92114348, filed May 28, 2003.

### BACKGROUND OF INVENTION

1. Field of the Invention

This invention generally relates to an apparatus for detecting and decoding music format and a digital music sharing method for mobile phones, and more particularly toan apparatus for detecting and decoding music format and a digital music sharing method for mobile phones regardless of the music format.

2. Description of Related Art

Ringtone download is getting more and more popular among the mobile phone users. Many ISP providers and Internet content providers provide paid ringtone download service. In the past, most rigntones were monotonic. Later, polyphonic rigntones have been used and are popular among the mobile phone users. Today, a 32 polyphonic chord is very common and provide a more musical result of a ringtone.

Monotonic ringtones have a variety of formats such as RTTTL (Ringing Tones Test Transfer Language) format and I-Melody format. There are some software ringtone converters converting different formats into compatible ringtones for specific mobile phones.

For polyphonic ringtones, the supported formats are derived from MIDI and GM (General MIDI). To save the memory size and the transmitting time, the mobile phone manufacturers may adopt the variant of MIDI and GM standards for their mobile phones. Hence, the end users cannot download and share those files for their mobile phones because of the different data format. For example, SMAF format is the data format specification designed by YAMAHA, which has a main purpose to define the data expression of the multimedia contents for mobile device (mainly used in mobile phone). SMAF also supports an extended feature which can define display sequences of texts and graphics. SMAF can synchronize the sound sequence with pictures and texts easily. With this feature, it is now used as data expression of the multimedia contents. SP MIDI (Scalable Polyphony MIDI) format is a specification proposed by AMEI/MMA for 3rd Generation mobile applications. SP-MIDI allows to playback the data by devices with different polyphony capabilities by adding Maximum Instantaneous Polyphony (MIP) message to a standard MIDI file; a musician can create a multi channel work and set up rules so that the most important parts of the music play on devices with limited capability while more advanced phones can render all aspects of the song. Some manufacturers may adopt the MIDI standard to be compatible with the MIDI files available on the Internet.

Because the manufacturers adopt different format for their own mobile phone, the end users may not share their ringtones or download ringtones in different formats on their mobile phones unless they use the software ringtone converters converting different formats into compatible ringtones for specific mobile phones.

### SUMMARY OF INVENTION

An object of the present invention is to decode files in any music format so that the end users don't have to worry about the ringtone incompatibility with their mobile phones.

In accordance with the above objects and other advantages of the present invention, an apparatus for detecting and decoding music format for mobile phones is provided. The apparatus for detecting and decoding music format for mobile phones comprises a receiver for receiving a digital music file; and a data processing unit, for detecting the format of the digital music file and decoding the digital music file responsive to the detected format of the digital music file. In a preferred embodiment of the present invention, the data processing unit includes a central processing unit for receiving the digital music file from the receiver, and a music IC. The music IC detects the format of the digital music file and decodes the digital music file.

In a preferred embodiment of the present invention, the music IC includes a firmware to decodes the digital music file responsive to the detected format of the digital music file.

The present invention also provides a method of sharing digital music for mobile phones, comprising the steps of providing a digital music file; transmitting the digital music file to a mobile phone; wherein the mobile phone detects the format of the digital music file and decodes the digital music file.

In a preferred embodiment of the present invention, the step of detecting the format of the digital music file and decoding the digital music file by the mobile phone further comprisesobtaining a header of the digital music file, wherein the header has an ID; determining the format of the digital music file responsive to the ID; obtaining a decoding procedure corresponding to the detected format of the digital music file; and performing the decoding procedure to decode the digital music file.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a system block diagram of a preferred embodiment in accordance with the present invention.

FIG. 2 is a system block diagram of another preferred embodiment in accordance with the present invention.

FIG. 3 is a flow chart for detecting and decoding the digital music file in accordance with a preferred embodiment of the present invention.

FIG. 4 is a flow chart for detecting and decoding the digital music file in accordance with another preferred embodiment of the present invention.

### DETAILED DESCRIPTION

Because the digital music files are composed based on MIDI standard proposed by MMA, the decoding procedures and the required hardware are very similar (e.g., FIFO, CPU interface, command register, etc), in a preferred embodiment of the present invention, a firmware is used to simplify the decoding procedure when decoding different formats.

FIG. 1 is a system block diagram of a preferred embodiment in accordance with the present invention. In this preferred embodiment, the service network 100 transmits a calling signal including a digital music file to a receiver 110 in the end user's mobile phone 10. After demodulation, the demodulated signal is sent to a data processing unit 120. The data processing unit 120 includes a central processing unit 122 and a music IC 124. The data processing unit 120 detects the format of the received digital music file and decodes the digital music file according to a decoding procedure corresponding to detected format of the received digital music file.

In a preferred embodiment of the present invention, the central processing unit 122 only deals with the baseband signals. The music IC 124 takes care of detecting and decoding operation via a firmware. In another preferred embodiment of the present invention, the central processing unit 122 also can detect the format of the received digital music file; the music IC 124 decodes the digital music file according to a decoding procedure corresponding to detected format of the received digital music file detected by the central processing unit 122.

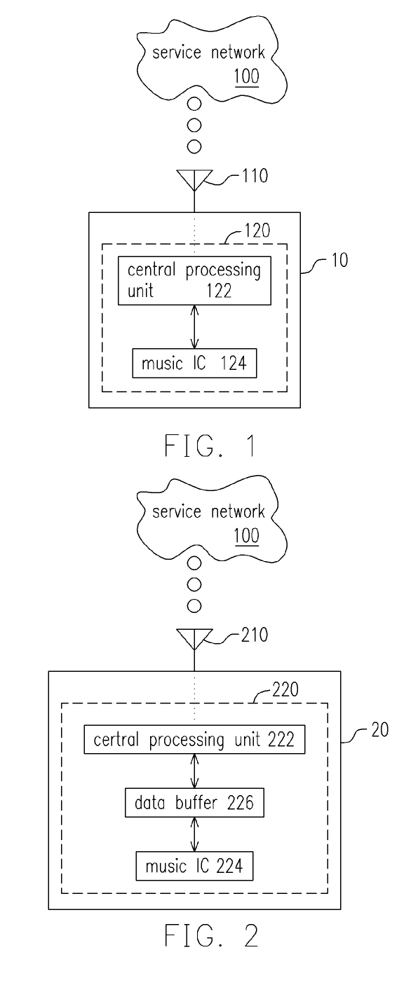

In another preferred embodiment of the present invention, the data processing unit further includes a data buffer. Referring to FIG. 2, the data processing unit 220 of the mobile phone 20 includes a central processing unit 222, a music IC 224, and a data buffer 226. The data buffer 226 is coupled to the central processing unit 222 and the music IC 224 for transmitting data between the central processing unit 222 and the music IC 224.

In a preferred embodiment of the present invention, the central processing unit 222 only deals with the baseband signals. The music IC 224 takes care of detecting and decoding operation via a firmware. The data buffer 226 receives and temporarily stores the digital music file and transmit the temporarily stored digital music file to the music IC 224.

In another preferred embodiment of the present invention, the central processing unit 222 also can detect the format of the received digital music file. The data buffer 226 receives and temporarily stores the digital music file and the detected format, and transmit the temporarily stored digital music file and the detected format to the music IC 224. The music IC 224 decodes the digital music file according to a decoding procedure corresponding to detected format of the received digital music file detected by the central processing unit 222.

Furthermore, in another preferred embodiment of the present invention, the function of the music IC also can be replaced by the central processing unit. This may imposes more burden upon the central processing unit, but it reduces the cost for designing and setting the music IC.

Moreover, one skilled in the art may also easily apply the present invention to decode the music formats combining texts and sounds such as ADPCM and MP3.

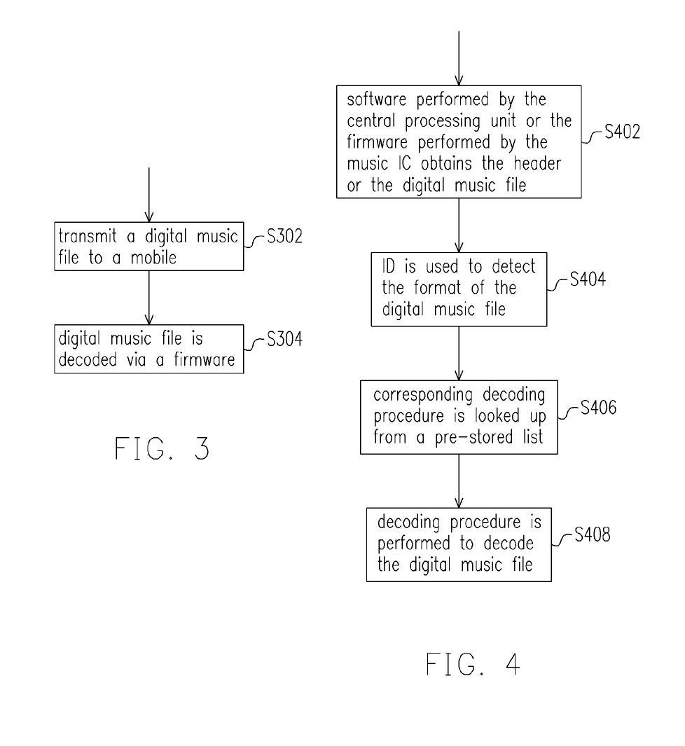

FIG. 3 is a flow chart for detecting and decoding the digital music file in accordance with a preferred embodiment of the present invention. The present invention is performing by first transmitting a digital music file to a mobile phone (S302). The mobile phone detects the format of the digital music file, and then decodes the digital music file via a firmware (S304).

FIG. 4 is a flow chart showing how the mobile phone detects the format of the digital music file and decodes the digital music file. First, the software performed by the central processing unit or the firmware performed by the music IC has to obtain the header of the digital music file (S402). One skilled in the art can easily obtain the related information regarding the header based on the related protocols. The header information includes a specific ID assigned for a specific music format. Thus the ID will be used to detect the format of the digital music file (S404).

After obtaining the ID, the format is determined. Hence, the corresponding decoding procedure can be looked up from a pre-stored list (S406) of decoding procedures.

Then the decoding procedure is performed to decode the digital music file (S408).

Accordingly, the present invention supports multiple formats such as MIDI, SP-MIDI, SMAF, MFi, RTTTL and M-melody by using firmware to detect and decode the digital music file. It also can support other additional formats by modifying the firmware code layer without changing the hardware.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. An apparatus for detecting and decoding music formats for mobile phones, comprising:
a receiver, for receiving a digital music file; and
a data processing unit, for detecting a format of said digital music file and decoding said digital music file responsive to the detected format of said digital music file.

2. The apparatus for detecting and decoding music formats for mobile phones of claim 1, wherein said data processing unit further comprises
a central processing unit, for receiving said digital music file from said receiver; and
a music IC, for detecting the format of said digital music file and decoding said digital music file via a firmware.

3. The apparatus for detecting and decoding music formats for mobile phones of claim 2, wherein said data processing unit further comprises
a data buffer, coupled to said central processing unit and said music IC, said data buffer receiving and temporarily storing said digital music file and transmitting said temporarily stored digital music file to said music IC.

4. The apparatus for detecting and decoding music formats for mobile phones of claim 1, wherein said digital musical file is a MIDI file.

5. The apparatus for detecting and decoding music formats for mobile phones of claim 1, wherein the format of said digital musical file is selected from a group of formats consisting of MIDI, SP-MIDI, SMAF, MFi, RTTTL, and I-Melody.

6. The apparatus for detecting and decoding music formats for mobile phones of claim 1, wherein said data processing unit further comprises;
a central processing unit, for receiving said digital music file from said receiver and detecting the format of said digital music file; and
a music IC, for selecting a decoding procedure corresponding to the detected format of said digital music format by central processing unit to decode said digital music file.

7. The apparatus for detecting and decoding music formats for mobile phones of claim 6, wherein said data processing unit further comprises
a data buffer, coupled to said central processing unit and said music IC, said data buffer receiving and temporarily storing said digital music file and transmitting said temporarily stored digital music file to said music IC.

8. A method of sharing digital music for mobile phones, comprising:
providing a digital music file; and
transmitting said digital music file to a mobile phone, wherein said mobile phone detects a format of said digital music file and decodes said digital music file.

9. A method of sharing digital music for mobile phones, wherein the step of detecting the format of said digital music file and decoding said digital music file by the mobile phone further comprises:
obtaining a header of said digital music file, said header having an ID;
determining a format of said digital music file responsive to said ID;
obtaining a decoding procedure corresponding to the detected format of said digital music file; and
performing said decoding procedure to decode said digital music file.
